(19) United States
(12) Patent Application Publication
(10) Pub. No.: US 2002/0087519 A1
(43) Pub. Date: Jul. 4, 2002

(54) Data distribution method and system

(75) Inventors: Byron C. Gehman, Cedar Park, TX (US); David G. Robinson, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation

(21) Appl. No.: 09/738,064

(22) Filed: Dec. 15, 2000

(51) Int. Cl. G06F 7/00

(52) U.S. Cl. 707/3

(57) ABSTRACT

A data distribution system comprising a database, a client and a server are disclosed. The client provides a data set request to the server. The server retrieves a first data block from the database that is responsive to the data set request. The server establishes an enumerator to provide the first data block to the client when the first data block is the only data block within the database that is responsive to the data set request. The server establishes a data provider and an enumerator when the first data block is one of two or more data blocks responsive to the data set request. The data provider retrieves two or more of the responsive data blocks, and provides the enumerator to the client. The enumerator has the first data block stored therein and provides the first data block to the client. Upon a provision of a portion of the first data block, the enumerator provides a data block request to the data provider for a second data block. The data provider provides the second data block to the enumerator in response to the data block request.

### BACKGROUND OF THE INVENTION

1. Field of the Invention

The present invention generally relates to data distribution systems, and more particularly distributed management of data sets resulting from a data set request of a database.

2. Description of the Related Art

Directories are used to store large amounts of information that can be searched and listed by a variety of different software clients. Thus, distributed management of the data must take into account several dilemmas.

First, a software client performing a search or list operation on a directory can receive a data set that is responsive to its request for information, but consumes all available memory of the client to the point where the client code stops running in an error condition. Second, directory server software is also vulnerable to running out of available memory when retrieving the data set for the client. Any attempts to buffer the data set by the server can create an out of memory error. Third, directory server resources can be rapidly consumed in a distributed environment having multiple clients performing directory operations.

The computer industry is therefore continually striving to improve upon the distribution by a server of a data set from a database to a client.

### SUMMARY OF THE INVENTION

One form of the present invention is a first method for distributing a data set. In one embodiment, a database is searched in response to a data set request from a client. A first data block and a second data block responsive to the data set request from the database are retrieved. An enumerator having the first data block stored therein is established and provided to the client.

In a second embodiment, a data provider and an enumerator are established in response to a data set request from a client. The enumerator having a first data block responsive to the data set request stored therein is provided to the client. The data provider is operated to retrieve a second data block responsive to the data set request.

In a third embodiment, a database is searched in response to a data set request from a client. The amount of any data blocks responsive to the data set request within the database is determined. An enumerator is established when only a first data block responsive to the data set request is being stored within the database. An enumerator and a data provider are established when the first data block and a second data block responsive to the data set request are being stored within the database.

A second form of the present invention is a distributed computing system comprising a database, a client, and a server. The database is operable to store a data set responsive to a data set request. The client is operable to provide the data set request. The server is operable to establish a data provider and an enumerator in response to the data set request. The data provider is operable to retrieve a first data block of the data set and a second data block of the data set from the database. The enumerator is operable to provide the first data block and the second data block to the client.

A third form of the present invention is a computer program product in a computer usable medium. The computer program product comprises a means for searching a database in response to a data set request, a means for establishing a first enumerator when the search of the database only yields a first data block responsive to the data set request; and a means for establishing a second enumerator and a data provider when the search of the database yields the first data block and a second data block responsive to the data set request.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1A is schematic diagram of network of distributed data processing systems as known in the art;

FIG. 1B is a schematic diagram of a computer architecture of a data processing system as known in the art;

FIG. 2 is a block diagram of a client, a server, and a database in accordance with the present invention;

FIG. 3A is flow chart illustrating one embodiment of a data set management routine in accordance with the present invention;

FIGS. 3B-3D are block diagrams of exemplary interactions between the FIG. 2, client, the FIG. 2 server, and the FIG. 2 during an implementation of the FIG. 3A data set management routine;

FIG. 4A is flow chart illustrating one embodiment of a data block management routine in accordance with the present invention;

FIGS. 4B-4E are block diagrams of exemplary interactions between the FIG. 2, client, the FIG. 2 server, and the FIG. 2 during an implementation of the FIG. 4A data block management routine;

FIG. 5A is flow chart illustrating one embodiment of a data item management routine in accordance with the present invention; and

FIGS. 5B and 5C are block diagrams of exemplary interactions between the FIG. 2, client, the FIG. 2 server, and the FIG. 2 during an implementation of the FIG. 5A data item management routine.

### DETAILED DESCRIPTION OF THE PRESENTLY PREFERRED EMBODIMENTS

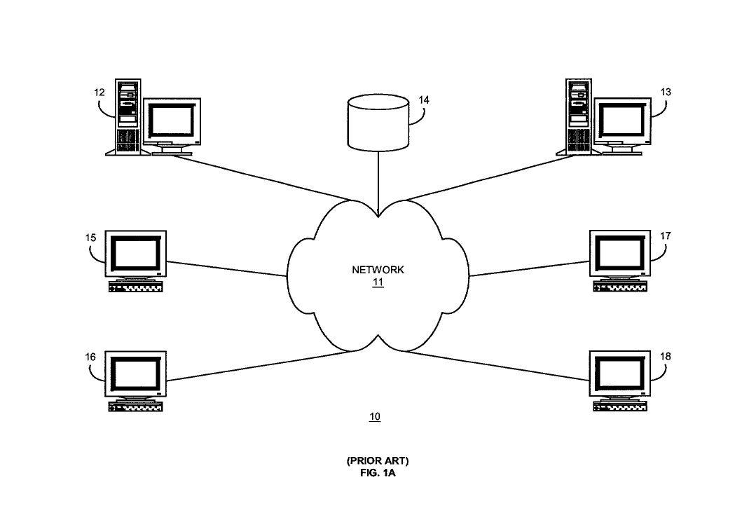

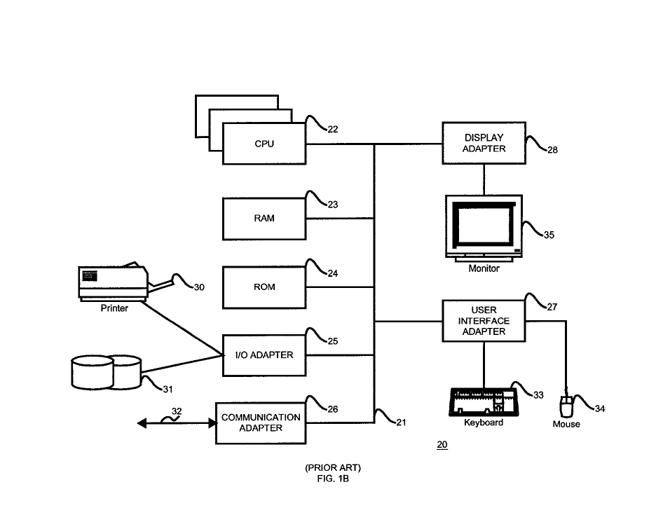

With reference now to the figures, FIG. 1A depicts a network of data processing systems. Distributed data processing system 10 contains network 11, which is the media used to provide communications links between various devices and computers connected together within distributed data processing system 10. Network 11 may include permanent connections, such as wire or fiber optic cables, or temporary connections made through telephone or wireless communications.

In the depicted example, a server 12 and a server 13 are connected to network 11 along with a database 14. In addition, a client 15, a client 16, a client 17, and a client 18 are connected to network 11. Servers 12 and 13, and clients 14-17 may be represented by a variety of computing devices, such as mainframes, personal computers, personal digital assistants (PDAs), etc. Distributed data processing system 10 may includes additional servers, clients, networks, routers, and other devices not shown.

Distributed data processing system 10 may include the Internet with network 11 representing a worldwide collection of networks and gateways that use the TCP/IP suite of protocols to communicate with one another. Of course, distributed data processing system 10 may also include a number of different types of networks, such as, for example, an intranet, a local area network (LAN), or a wide area network (WAN).

The present invention could be implemented on a variety of hardware platforms. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 20 contains one or more central processing units (CPUs) 22 connected to internal system bus 21, which interconnects random access memory (RAM 23, read-only memory (ROM) 24, and input/output adapter 25, which supports various I/O devices, such as printer 30, disk units 31, or other devices not shown, such as a sound system, etc. A communication adapter 26, a user interface adapter 27, and a display adapter 28 are also connected to bus 21. Communication adapter 26 provides bus 21 with access to a communication link 32. User interface adapter 27 connects bus 21 to various user devices, such as keyboard 33 and mouse 34, or other devices not shown, such as a touch screen, stylus, etc. Display adapter 28 connects bus 21 to a display device 35.

Those of ordinary skill in the art will appreciate that the hardware in FIG. 1B may vary depending on the system implementation. For example, the system may have one or more processors, and other peripheral devices may be used in addition to or in place of the hardware depicted in FIG. 1B The depicted example is not meant to imply architectural limitations with respect to the present invention. In addition to being able to be implemented on a variety of hardware platforms, the present invention may be implemented in a variety of software environments. A typical operating system may be used to control program execution within the data processing system.

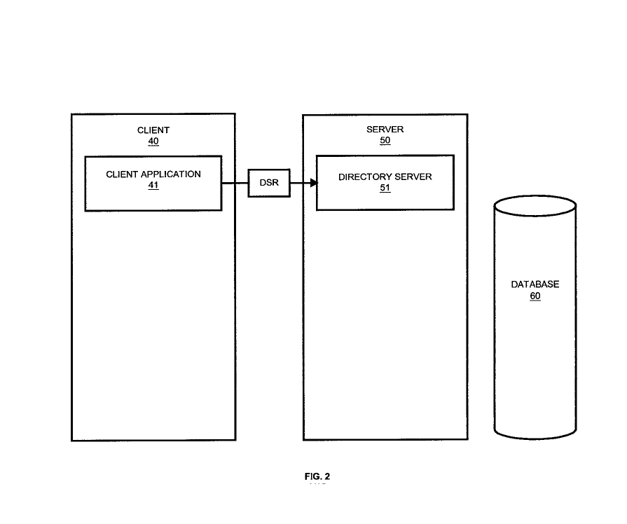

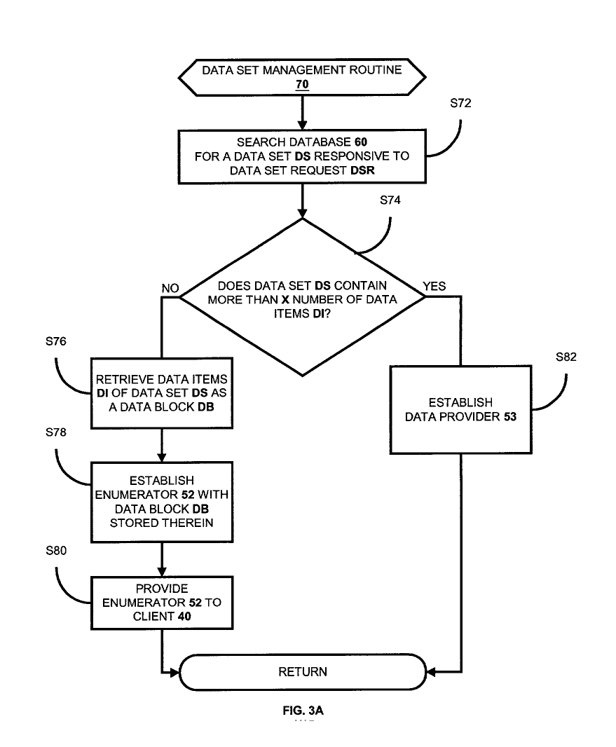

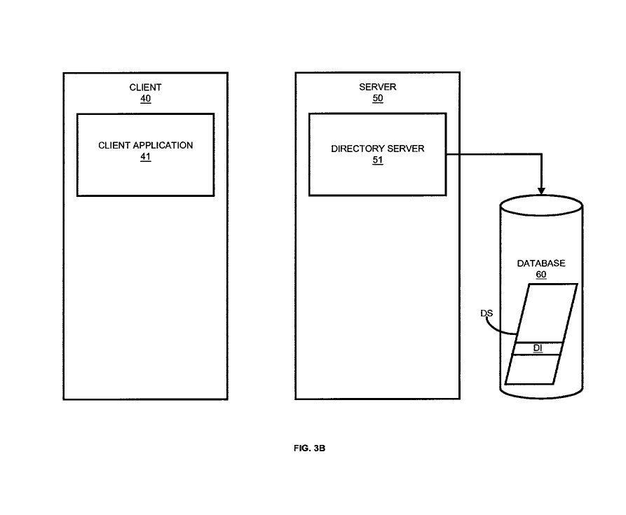

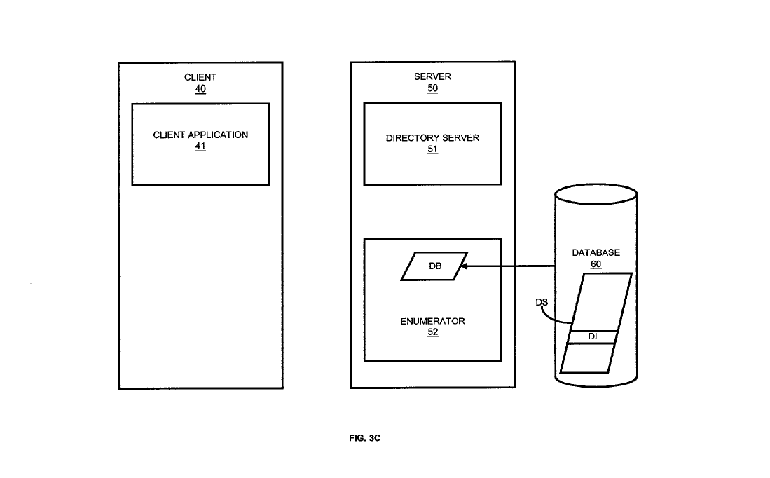

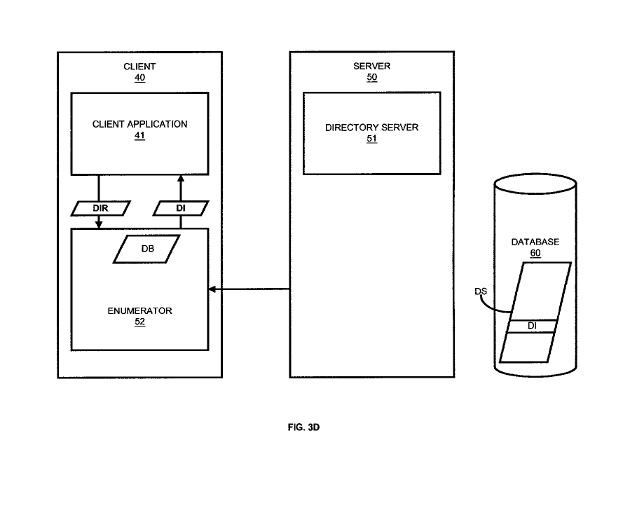

Referring to FIG. 2, a client 40, a server 50, and a database 60 of the present invention are shown. Client 40 includes a client application 41 for providing a data set request DSR to an object of server 50 in the form of directory server 51. Data set request DSR can be representative of either a search request or a listing request as would occur to those with ordinary skill in the art. Upon receipt of data request set DSR, directory server 51 implements a data set distribution routine 70 as shown in FIG. 3A.

Referring to FIGS. 3A and 3B, during a stage S72 of routine 70, directory server 51 searches database 60 for a data set DS that is responsive to data request set DSR. Upon an identification of data set DS, directory server 51 proceeds to stage S74 of routine 70 to determine if data set DS contains more than a X number of data items DI. A single data item DI for purposes of the present invention is defined as one (1) or more pieces of information, e.g., a row of information as illustrated in FIG. 3B. As known by those with ordinary skill in the art, client application 41 consumes each data item DI as it is received. Number X is therefore a pre-configured number that is less than or equal to an estimated maximum quantity of data items DI client 40 can hold while hold while effectively and timely performing its assigned duties, e.g., number X can be 150 rows of data items DI. Ideally, number X equals the estimated maximum quantity of data items DI. However, it may be prudent to establish number X as less than the estimated maximum quantity of data items DI in view of other factors, such as, for example, an estimated maximum degree of parallel processing that may be performed by client 40 and an estimated maximum quantity of data items DI server 50 can hold while effectively and timely performing its assigned duties.

Referring to FIGS. 3A and 3C, if directory server 51 determines during stage S74 of routine 70 that data set DS contains X number or less of data items DI, directory server 51 proceeds to stage S76 to retrieve a data block DB including X number or less of data items DI. Directory server 51 then proceeds to stage S78 to establish an enumerator 52 and to store data block DB within enumerator 52.

Referring to FIGS. 3A and 3D, directory server 51 provides enumerator 52 to client 40 during a stage S80 of routine 70. As known to those of ordinary skill in the art, enumerator 52 provides a data item DI to client application 41 in response to a corresponding data item request DIR from client application 41 until data block DB is depleted of data items DI.

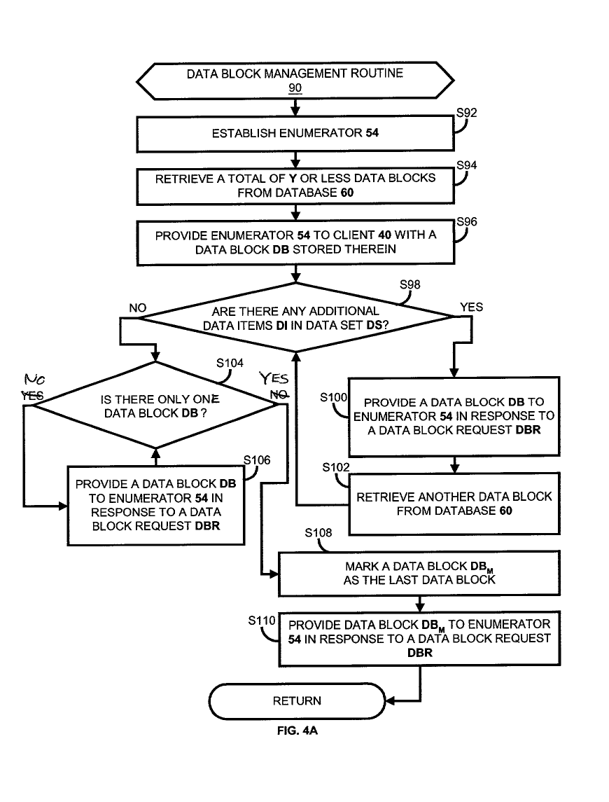

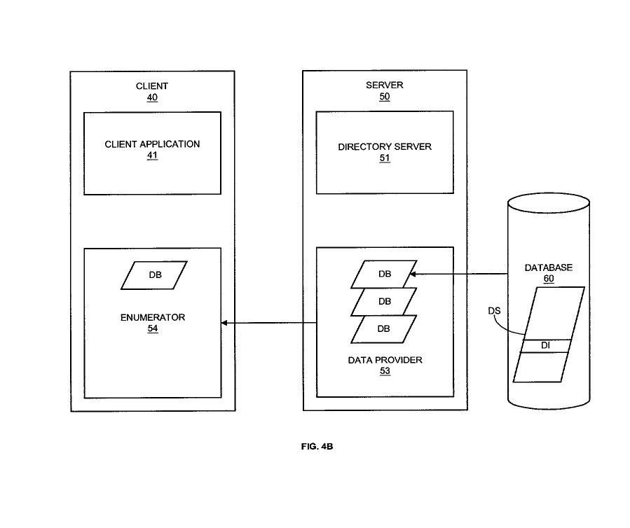

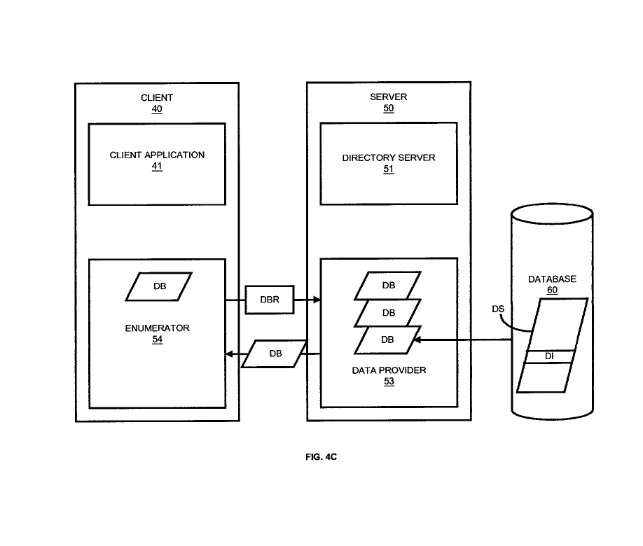

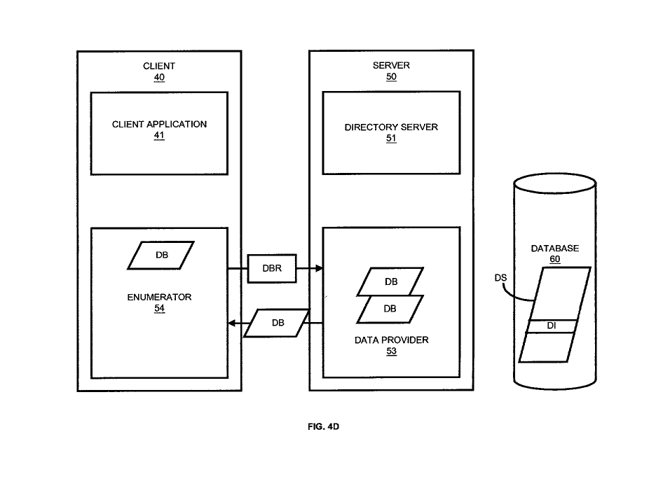

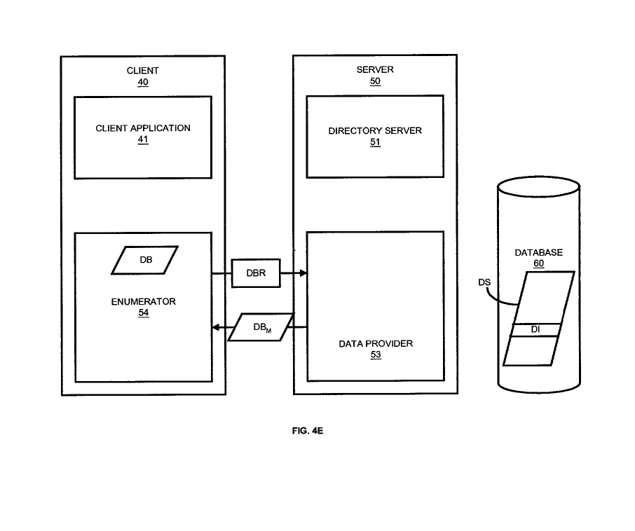

Referring again to FIGS. 3A and 3B, if directory server 51 during stage S74 of routine 70 determines that data set DS contains more than X number of data items DI, directory server 51 proceeds to stage S82 of routine 70 to establish an object in the form of data provider 53. Data provider 53 implements a data block management routine 90 as shown in FIG. 4A.

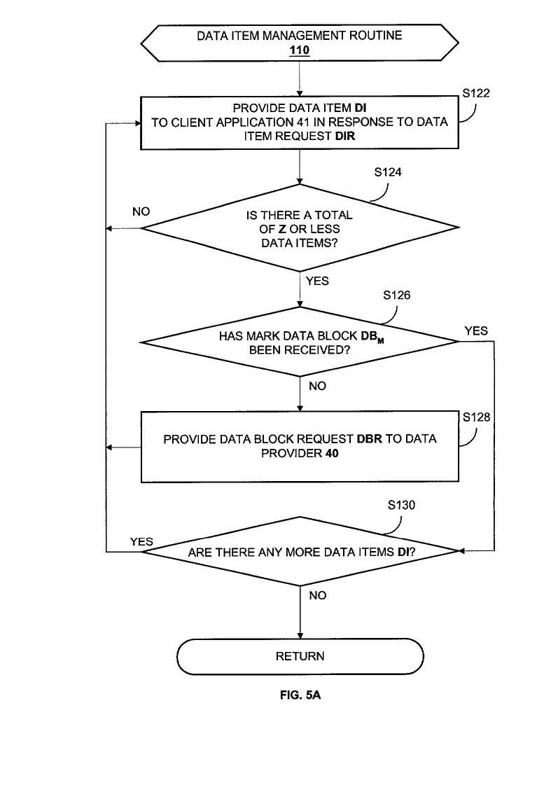

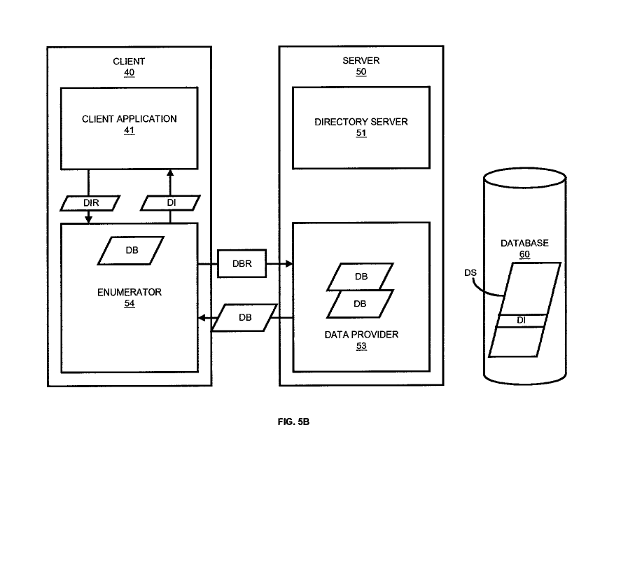

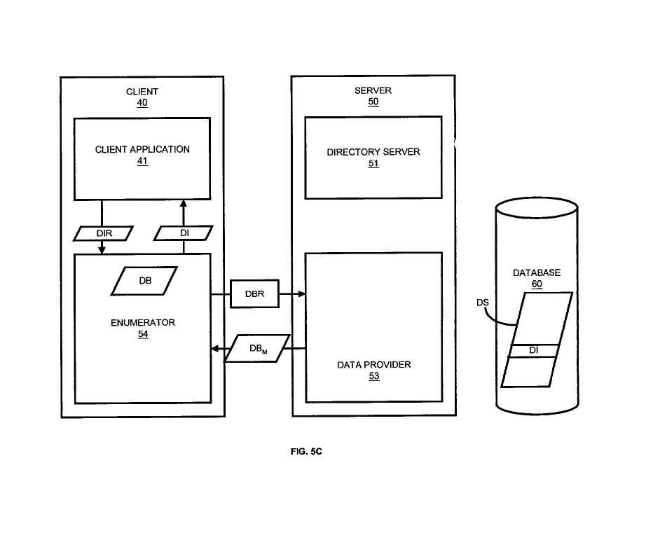

Referring to FIGS. 4A and 4B, during a stage S92 of routine 90, data provider 53 establishes an enumerator 54 for implementing a data item management routine 120 as will be subsequently described herein in connection with FIG. 5. Data provider 53 proceeds to stage S94 of routine 90 to retrieve a Y number or less of data blocks DB from database 60. Those of ordinary skill in the art will appreciate that each data block DB will contain the X number of data items DI with the last data block DB containing the X number or less of data items DI. Number Y is a pre-configured number that is less than or equal to an estimated maximum quantity of data blocks DB data provider 53 can hold while server 50 effectively and timely performs its duties, e.g., number Y is three (3) data blocks DB of 150 data items DI. Ideally, number Y equals the estimated maximum quantity of data blocks. However, it may be prudent to establish number Y as less than the estimated maximum quantity of data blocks in view of other factors, such as, for example, an estimated maximum quantity of data set requests DSR (FIG. 2) directory server 51 can simultaneously process. Data provider 53 then proceeds to stage S96 of routine 90 to provide enumerator 54 having one of the data blocks DB stored therein to client 40. During a stage S98 of routine 90, data provider 53 determines if there are any additional data items DI within data set DS.

Referring to FIGS. 4A and 4C, if data provider 53 determines during stage S98 that there are additional data items DI within data set DS, data provider 53 will proceed to stage S100 of routine 90 to provide one of the data blocks DB to enumerator 54 in response to a data block request DBR from enumerator 54. Data provider 53 then proceeds to stage S102 of routine 90 to retrieve another data block DB from database 60, the data block DB having X number or less of data items DI. Data provider 53 returns to stage S98 upon completion of stage S102.

Referring to FIGS. 4A and 4D, if data provider 53 determines during stage S98 that there are no additional data items DI within data set DS, data provider 53 proceeds to stage S104 of routine 90 to determine if there is only data block DB within data provider 53. Data provider 53 proceeds to stage S106 of routine 90 to provide one of the data blocks DB to enumerator 54 in response to a data block request DBR from enumerator 54 when there are two or more data blocks DB within data provider 53. Data provider 53 returns to stage S104 upon completion of stage S106.

Referring to FIGS. 4A and 4E, if data provider 53 determines during stage S104 that there is only one data block DB within data provider 53, data provider 53 proceeds to stage S 08 of routine 90 to mark the data block DB_{M} and then proceeds to stage S110 of routine 90 to provide data block DB_{M} to enumerator 54 in response to a data block request DBR from enumerator 54.

Referring to FIGS. 5A and 5B, during a stage S122 of routine 120, enumerator 54 provides a data item DI to client application 40 in response to a corresponding data item request DIR from client application 40. During stage S124, enumerator 54 determines if there is a Z number or less of data items within enumerator 54. Number Z is a pre-configured number that is equal to or greater than number X by an amount that still allows client 40 to effectively and timely perform its assigned duties, e.g. number Z can be 200 data items DI. If enumerator 54 determines during stage S121 that there are more than Z number of data items DI within enumerator 54, enumerator 54 returns of to stage S122.

If enumerator 54 determines during stage S124 that there are Z number or less of data items within enumerator 54, enumerator 54 proceeds to stage S126 to determine if the marked data block DB_{M} has been received. If enumerator 54 determines during stage S126 that the marked data block DB_{M} has not been received, then enumerator 54 proceeds to stage S128 to provide a data block request DBR to data provider 53 and then returns to stage S122.

Referring to FIGS. 5A and 5C, if enumerator 54 determines during stage S126 if is marked data block DB_{M} has been received, then enumerator 54 proceeds to stage S130 to determine if there in any data item DI within enumerator 54. If enumerator 54 determines during stage S130 that there is one or more data items DI within enumerator 54, then enumerator 54 returns to stage S122. If enumerator 54 determines during stage S130 that there are no more data items DI within enumerator 54, then enumerator 54 terminates routine 120.

Referring to FIGS. 4A and 5A, another feature of the present invention involves terminating routines 120 when a time interval between successive reception of a data base DB by enumerator 54 from data provider 53 exceeds a pre-configured time interval. By way of example, with a pre-configured time interval of two (2) minutes, data provider 43 will terminate routine 90 and routine 120 when a completion of stage S96 of routine 90 and a commencement of stage S128 of routine 120 exceeds two (2) minutes. Also by example, data provider 43 will terminate routine 90 and routine 120 when a completion of stage S128 of routine 120 and a commencement of a subsequent implementation of stage S128 of routine 120 exceeds two (2) minutes. Those with ordinary skill in the art will appreciate this protection from overburdening server 50.

It is important to note that while the present invention has been described in the context of a fully functioning data processing system, those of ordinary skill in the art will appreciate that the processes of the present invention are capable of being distributed in the forms of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, CD-ROM, and transmission-type media, such as digital and analog communications links.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method, comprising:
searching a database in response to a data set request from a client;
retrieving a first data block and a second data block responsive to said data set request from said database;
establishing an enumerator; and
providing said enumerator to a client, said enumerator having said first data block stored therein.

2. The method of claim 1, further comprising:
operating said enumerator to provide a first portion of said first data block to said client;
operating said enumerator to provide a first data block request for said second data block upon providing said first portion of said first data block to said client; and
providing said second data block to said enumerator in response to said first data block request.

3. The method of claim 2, further comprising:
operating said enumerator to provide a second portion of said first data block to said client, said first data block consisting of said first portion and said second portion; and
operating said enumerator to provide said second data block to said client.

4. The method of claim 2, further comprising:
operating said enumerator to provide a first portion of said second data block to said client; and
operating said enumerator to provide a second data block request for a third data block responsive to said data set request upon providing said first portion of said second data block to said client.

5. The method of claim 4, further comprising:
retrieving said third data block from said database; and
providing said third data block to said enumerator in response to said second data block request.

6. A method, comprising:
establishing a data provider and an enumerator in response to a data set request from a client;
providing said enumerator to a client, said enumerator having a first data block responsive to said data set request stored therein; and
operating said data provider to retrieve a second data block responsive to said data set request.

7. The method of claim 6, further comprising:
operating said enumerator to provide a first portion of said first data block to said client;
operating said enumerator to provide a first data block request for said second data block to said data provider upon providing said first portion of said first data block to said client; and
operating said data provider to provide said second data block to said enumerator in response to said first data block request.

8. The method of claim 7, further comprising:
operating said enumerator to provide a second portion of said first data block to said client, said first data block consisting of said first portion and said second portion; and
operating said enumerator to provide said second data block to said client.

9. The method of claim 7, further comprising:
operating said enumerator to provide a first portion of said second data block to said client; and
operating said enumerator to provide a second data block request for a third data block to said data provider upon providing said first portion of said second data block to said client, said third data block being responsive to said data set request.

10. The method of claim 9, further comprising:
operating said data provider to retrieve said third data block; and
operating said data provider to provide said third data block to said enumerator in response to said second data block request.

11. A method, comprising:
searching a database in response to a data set request from a client;
determining if said database is storing any data blocks responsive to said data set request;
establishing a first enumerator when only a first data block responsive to said data set request is being stored within said database; and
establishing a second enumerator and a data provider when said first data block and a second data block responsive to said data set request are being stored within said database.

12. The method of claim 11, further comprising:
operating said second enumerator to provide a first portion of said first data block to said client;
operating said second enumerator to provide a first data block request for said second data block to said data provider upon providing said first portion of said first data block to said client; and
operating said data provider to provide said second data block to said second enumerator in response to said first data block request.

13. The method of claim 12, further comprising:
operating said second enumerator to provide a second portion of said first data block to said client, said first data block consisting of said first portion and said second portion; and
operating said second enumerator to provide said second data block to said client.

14. The method of claim 12, further comprising:
operating said second enumerator to provide a first portion of said second data block to said client; and
operating said second enumerator to provide a second data block request for a third data block of said at least two data blocks to said data provider upon providing said first portion of said second data block to said client.

15. The method of claim 14, further comprising:
operating said data provider to retrieve said third data block from said database; and
operating said data provider to provide said third data block to said second enumerator in response to said second data block request.

16. A distributed computing system, comprising:
a database operable to store a data set responsive to a data set request;
a client operable to provide said data set request; and
a server operable to establish a data provider and an enumerator in response to said data set request, wherein
said data provider is operable to retrieve a first data block of said data set and a second data block of said data set from said database, and
said enumerator is operable to provide said first data block and said second data block to said client.

17. The distributed computing system of claim 16, wherein
said data provider is further operable to provide said first data block to said enumerator; and
said enumerator is operable to provide a first data block request for said second data block to said data provider upon providing a first portion of said first data block to said client.

18. The distributed computing system of claim 17, wherein
said data provider is further operable to provide said second data block to said enumerator in response to said data block request.

19. The distributed computing system of claim 18, wherein
said data provider is further operable to provide a third data block of said data set from said database; and
said enumerator is further operable to provide a second data block request for said third data block to said data provider upon providing a first portion of said second data block to said client.

20. The distributed computing system of claim 16, wherein
said data provider is further operable to provide said first data block to said enumerator;
said enumerator is further operable to provide a data block request for said second data block to said data provider; and
said data provider is further operable to provide said second data block to said enumerator in response to said data block request.

21. A computer program product in a computer useable medium, comprising:
a means for searching a database in response to a data set request;
a means for establishing a first enumerator when said search of said database only yields a first data block responsive to said data set request; and
a means for establishing a second enumerator and a data provider when said search of said database yields said first data block and a second data block responsive to said data set request.

22. The computer program product of claim 21, further comprising:
a means for operating said second enumerator to provide a first portion of said first data block to said client;
a means for operating said second enumerator to provide a first data block request for said second data block to said data provider upon providing said first portion of said first data block to said client; and
a means for operating said data provider to provide said second data block to said second enumerator in response to said first data block request.

23. The computer program product of claim 22, further comprising:
operating said second enumerator to provide a second portion of said first data block to said client, said first data block consisting of said first portion and said second portion; and
operating said second enumerator to provide said second data block to said client.

24. The computer program product of claim 22, further comprising:
operating said second enumerator to provide a first portion of said second data block to said client; and
operating said second enumerator to provide a second data block request to said data provider for a third data block responsive to said data set request upon providing said first portion of said second data block to said client.

25. The computer program product of claim 24, further comprising:
a means for operating said data provider to retrieve said third data block from said database; and
a means for operating said data provider to provide said third data block to said second enumerator in response to said second data block request.
